(19) United States
(12) Patent Application Publication
(10) Pub. No.: US 2008/0294375 A1
(43) Pub. Date: Nov. 27, 2008

(54) Method and Device for Selecting Multimedia Items, Portable Preference Storage Device

(75) Inventor: Albertus Josephus Nicolaas Van Breemen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,011

(22) PCT Filed: Jun. 17, 2005
(86) PCT No.: PCT/IB2005/052004

§ 371 Date: Dec. 20, 2006

(30) Foreign Application Priority Data
Jun. 22, 2004 (EP) 04102865.5

(51) Int. Cl. G06F 17/18

(52) U.S. Cl. 702/181

(57) ABSTRACT

A method of automatically selecting an item (e.g. s₃) from a set (S) of items involves using item properties to determine weighing factors. The weighing factors are then used to produce a preference distribution having sections, the relative sizes of which correspond with the respective weighing factor. A random number may be used to point to a section of the preference distribution and thus select the associated item. The method may be used to select multimedia items, such as songs, stored in a mass storage device.

The present invention relates to selecting items. More in particular, the present invention relates to a method of selecting items, such as multimedia items, out of a set of such items.

Present-day technology allows large numbers of multimedia items, such as songs or video clips, to be stored digitally on a relatively inexpensive storage medium, such as a hard disc. The user who wants to listen to and/or view some of these items is faced with the problem of choice: which items does she want to be played, considering that the number of available items is much greater than the number of items she is able to listen to and/or view within a certain period of time.

It is known to provide “playlists”, predetermined lists that each identify a limited number of multimedia items. These “playlists” offer the advantage of reducing the number of different options the user may choose from, as typically there are far fewer playlists than items. However, as playlists are predetermined, they are static in that their contents cannot easily been altered. In addition, the problem of choosing items is not solved by playlists, it is only transformed into the problem of how to compose playlists. Composing playlists may be carried out manually by a user but has the disadvantage of being very time-consuming if the number of items is large. Automated playlist composition is possible but it has been found difficult to take user preferences into account, in particular as users may have shades of preferences between “like” and “dislike”, and furthermore because of the tedious manual interaction it is difficult to make/adapt playlists on the fly.

It is an object of the present invention to overcome these and other problems of the Prior Art and to provide a method and a device for selecting items which are flexible and take various user preferences into account.

Accordingly, the present invention provides a method of automatically selecting multimedia items, the method comprising the steps of:
determining, for each item, a likelihood factor on the basis of properties of the item,
cumulating the likelihood factors for all items so as to produce a selection range comprised of likelihood factors,
producing a selector number within said range, and
comparing the selector number with the cumulated likelihood factors so as to determine which item corresponds with the likelihood factor indicated by the selector number.

By determining likelihood factors on the basis of properties of the items, the properties of the items are translated into a likelihood of being selected. The likelihood factors are combined to form a selection range, larger factors representing a correspondingly larger likelihood of being selected. A (random or non-random) number within said range is then used to indicate the selected item. In this way, the properties of the items do indirectly determine whether an item may be selected: the properties do not directly determine the outcome of the selection process but only determine the likelihood of being selected. It has been found that this type of automatic selection process is very flexible and allows various properties and their values to be taken into account. The method of the present invention is automatic in that it is carried out by a computer and/or dedicated hardware.

In a preferred embodiment, the step of determining a likelihood factor involves determining a normalized weighing factor for each property of an item using a normalization function. By using a normalization function, the calculations involved in the selection process are greatly simplified. In particular, the resulting normalized weighing factors may easily be compared or multiplied as their ranges will typically be identical. It is noted that in preferred embodiments a separate normalization function will be provided for each individual property.

It is preferred that the step of determining a likelihood factor involves determining the product of all normalized weighing factors of an item so as to produce a item specific weighing factor. This item specific weighing factor therefore reflects all properties of the item.

Advantageously, the step of determining a likelihood factor involves determining the ratio of an item specific weighing factor and the sum of all item specific weighing factors. A likelihood factor therefore is a relative item specific weighing factor indicating the “importance” (or weight) of the item relative to all other items involved in the selection process.

It is preferred that a normalization function reflects user preferences. That is, a normalization function is designed or adapted (scaled and/or shifted along its property x-axis) to reflect the importance the user attaches to the particular property. In this way, user preferences may be very conveniently taken into consideration. In addition, a normalization function may be time-dependent and “evolve” over time, either automatically (typically on the basis of predetermined high-level heuristics which may be fine-tuned by the user) or under explicit user control, to reflect changing or time-dependent user preferences.

Advantageously, a normalization function may be user-controlled. A user interface may be provided which allows a user to alter her preferences as expressed in her normalization functions. Advantageously, a user may set an item specific weighing factor to zero, thus excluding the corresponding multimedia item from selection.

The items selected in accordance with the present invention are preferably multimedia items, such as songs, movies or video clips. However, the present invention is not so limited and may also be used for automatically selecting other items.

The method of the present invention may further comprise the step of storing selection history information. This selection history information may indicate when an item was last selected to be played or played, or the list of items which was played before. This step may, for example, involve marking a selected item so as to prevent repeated selection of the same item. Advantageously instead of storing the particulars of the items themselves, their characteristics in property space are stored, so that the selection process can be tuned to select items from (dis)similar regions of property space.

The history information, or any other information, may be stored in the device carrying out the selection method, and/or in a storage device, preferably a portable storage device, such as e.g. a memory stick, smart card, etc. Using a portable storage device offers the advantage that the history may be transferred to any other multimedia selecting and/or rendering device. A portable storage device may also contain normalization functions, normalized weighing factors and/or item specific weighing factors. In further embodiments any modifying parameters of said normalization functions may be stored on a (portable or non-portable) storage device. Examples of such modifying parameters are parameters that define a scaling or shifting of the function. For each function, a set of such control parameters (which control the function) could be stored, in embodiments including also their history.

The present invention also provides a computer program product for carrying out the method as defined above. The computer program product may comprise a carrier such as a CD, a DVD, a floppy disc, a memory stick or any other suitable carrier. Alternatively, the computer program product may be available for downloading from a remote or local source. Hence a user may e.g. continue to listen to music of his particular preference from the multimedia database of a friend at this friend's location by inserting the portable storage device with these preferences in the multimedia rendering system on that new location.

The present invention additionally provides a device for automatically selecting multimedia items, the device comprising:

means for determining, for each item, a likelihood factor on the basis of properties of the item,

means for cumulating the likelihood factors for all items so as to produce a selection range comprised of likelihood factors,

means for producing a selector number within said range, and

means for comparing the selector number with the cumulated likelihood factors so as to determine which item corresponds with the likelihood factor indicated by the selector number.

Said means may be constituted, for example, by a general purpose computer or a special purpose computer. A special purpose computer may be incorporated in a multimedia system, such as an audio and/or video system, in a smart card, or in another suitable portable device.

The present invention provides as well a preferably portable device for storing at least one normalization functions and/or at least one weighing factor and/or at least one likelihood factor for use in the method in the device as defined above. E.g. a fixed storage device may comprise a detachable memory unit such as a memory stick.

The present invention further provides a multimedia system, arranged for carrying out the method as defined above.

The present invention will further be explained below with reference to exemplary embodiments illustrated in the accompanying drawings, in which:

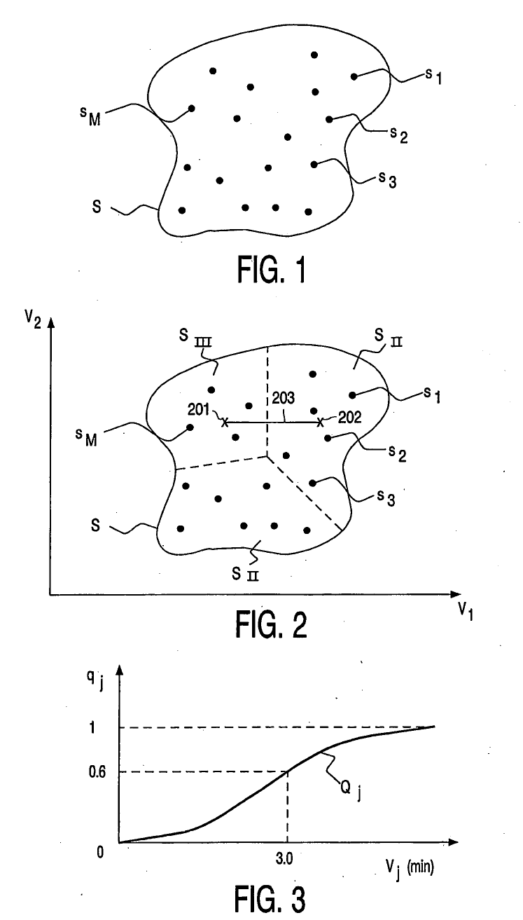

FIG. 1 schematically shows a first set of items from which an item is to be selected in accordance with the present invention.

FIG. 2 schematically shows a second set of items from which an item is to be selected in accordance with the present invention.

FIG. 3 schematically shows the relationship between a parameter and a weighing factor according to the present invention.

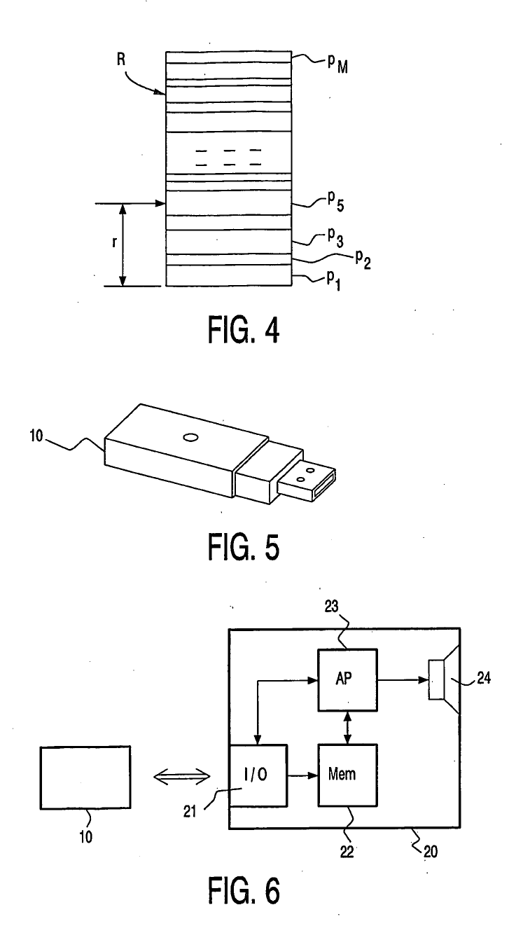

FIG. 4 schematically shows the selection of an item in accordance with the present invention.

FIG. 5 schematically shows a data carrier device in accordance with the present invention.

FIG. 6 schematically shows a music system in accordance with the present invention.

The set S shown merely by way of non-limiting example in FIG. 1 contains M items s₁, s₂, s₃, . . . , s_{M}. These items are, in the present example, multimedia items such as songs, video clips, and/or movies. In practice the number of items typically is much greater than is illustrated in FIG. 1 and the number M of items may be, for example, approximately 1000, 5000, 10000 or more. The large number of items makes it difficult to choose one, in particular if selection criteria are used. Such selection criteria may include, in the case of songs, the type of music, the name of the artist, the time duration of the song, and other criteria, and can be mathematically represented as a property space (v₁, v₂, . . . ). At a certain time of the day, or a particular occasion such as a friend's bachelor party, etc., a user may prefer certain items to other items. Of course an item may be selected purely at random, but such a random selection would not take the user preferences into account.

Accordingly, the present invention takes weighing factors into account which influence the probability of an item being selected. These weighing factors are derived from the properties of the items.

Each item has certain properties, such as the duration, the release date, the artist(s), the type of music (classical, jazz, reggae, hard rock) or movie (comedy, romance, war, documentary). For each set of items, a set of N properties vⱼ can be determined: v₁, v₂, . . . , v_{N}. The properties may have various values, the time duration of songs for example may vary from approximately 1 minute) to 5 minutes or more. Similarly, the type of music or the name of the artist may be represented by a number identifying an entry in a table containing hundreds or even thousands of entries.

The invention therefore uses normalized properties. To this end, a normalization curve representing a normalization function Q is defined for each property. An example of such a curve is illustrated in FIG. 3 where the property vⱼ is the time duration of songs in minutes. The corresponding weighing factor or normalized property qⱼ is shown to range from 0 to 1, the relationship between vⱼ and qⱼ being determined by the curve. For a song having a length of 3 minutes (vⱼ=3.0), the corresponding weighing factor qⱼ is, in the example of FIG. 3, equal to 0.6. It can be seen that the weighing factor qⱼ is greater than or equal to zero and never exceeds one.

It is noted that in the preferred embodiments the weighing factors qⱼ range from 0 to 1 as this simplifies any further calculations, but that this is not essential. The weighing factors could, for example, range from −1 to +1, or from 0 to 10. It is important, however, that all weighing factors have the same range as this allows the weighing factors to be combined in a single calculation. The [0,1] variant allows easy calculation in the framework of probabilities, but similar methods/devices can be designed along the rationale of the invention in other frameworks such as e.g. fuzzy logic.

It is further noted that the curve of FIG. 3 is exemplary only and that the actual function or curve used may have various shapes. The function Qⱼ shown is ascending and smooth, however, stepped and/or descending curves are also possible.

In general, each general property vⱼ can be converted into a corresponding weighing factor qⱼ (j being the property number). Accordingly, each individual property vᵢⱼ of an individual item sᵢ (i being the item number) corresponds with an individual weighing factor qᵢⱼ. If, for example, item S₂ in FIG. 1 is a song having a duration of 3 minutes and if “duration” is property number 5, then the corresponding weighing factor for that song is, in the example of FIG. 3, equal to 0.6.

The present invention utilizes these individual weighing factors qᵢⱼ to determine an item specific weighing factor qᵢ of the item sᵢ (i being the item number), where the item specific weighing factor qᵢ is the product of all individual property weighing factors of that item:

$${q}_{i} = {\prod }_{j = 1}^{N} {q}_{ij} \qquad ( 1 )$$

The item specific weighing factor qᵢ is therefore a measure of the combined properties of the item.

Subsequently the item specific weighing factor qᵢ is used to determine a relative weighing factor pᵢ for this item. This relative weighing factor or likelihood factor pᵢ is the ratio of the item specific weighing factor qᵢ for the item in question and the sum of the item specific weighing factor qₖ for all items:

$${p}_{i} = {q}_{i} / {\sum }_{k = 1}^{M} {q}_{k} \qquad ( 2 )$$

This relative weighing factor or likelihood factor pᵢ is a measure of the likelihood of selecting item i.

In a preferred embodiment of the invention these relative weighing factors pᵢ are cumulated (that is, stacked) to produce a weighing factor distribution R. An example of such a distribution R is shown in FIG. 4. As can be seen, the distribution R contains the relative weighing factors p₁, p₂, p₃, . . . , p_{M}, where each factor pᵢ forms a section of the stack R. Then an selector number r is chosen, preferably but not necessarily at random, and compared with the distribution R. The (magnitude of) the selector number r indicates a section of the distribution R, in the present example the section corresponding with the relative weighing factor p₅. Accordingly, item 5 is selected.

It will be understood that the range of the selector number r corresponds with the range of the distribution R, that is, with the height of the stack. Typically, the value of the number r will be between zero and one. In the example shown, r is equal to 0.35 and the relative weighing factor p₅ has a value (section height) of 0.11. As the sum of p₁ to p₄ equals 0.30, the section corresponding with p₅ extends from 0.30 to 0.41 (=0.30+0.11). Accordingly, the value of r (0.35) is within this section, hence item 5 is selected.

The relative weighing factors pᵢ will be relatively small numbers, depending on the number of items and the properties of each item. If the relative weighing factors are calculated in accordance with formula (2) above, their sum, and hence the height of the “stack” R, will be equal to one (except for any rounding errors).

As explained above, the present invention provides a very advantageous method of selecting items, based on their properties. The relative weighing factors (or likelihood factors) represent the likelihood of any item being selected: as shown in FIG. 4, items having a large relative weighing factor pᵢ are more likely to be selected than items having a small relative weighing factor pᵢ.

The selection process may be facilitated by dividing the set S of items sᵢ into two or more subsets S_{I}, S_{II}, etc., as illustrated in FIG. 2. The division of the set S may be carried out by mathematical techniques (e.g. clustering) assigning items to one of the subsets S_{I}, S_{II}, etc., so as to reduce the number of items involved in each selection, or (semi) user controlled e.g. by delineating on a user interface showing property space.

The selection process described above may in that case be preceded by a SUBSET selection step. The division of the set S is carried out on the basis of one or more properties of the items sᵢ, such that each subset S_{I}, S_{II}, . . . contains items having at least one common property. In certain embodiments, therefore, songs are assigned to each of the subsets on the basis of the property “type of music”, for example classical, jazz, hard rock, etc. It will be understood that such an assignment of items to subsets reduces the computational load of the subsequent selection process. Alternatively, once the subsets have been created on the basis of one or more properties, an item within a subset may be simply randomly selected, thus greatly simplifying the selection process. The partition could also be random purely to reduce computational load.

As will be clear from the above discussion, the functions Qⱼ illustrated in FIG. 3 determine how much weight is assigned to each property vⱼ, in other words, how the properties of an item are rated. The functions Qⱼ reflect user preferences and may be altered by a user. In addition, the functions Qⱼ may vary in time: a user may value classical music in the morning, hard rock in the afternoon and romantic music in the evening. This “evolution” of user preferences may therefore being reflected in a time-dependent function Qⱼ. Alternatively, or additionally, a user interface may be provided that allows a user to alter her preferences and/or the associated functions Qⱼ. The user may also be able to (directly or indirectly) set an item specific weighing factor qᵢ to zero, thus excluding the associated item from selection.

E.g. a popup window may allow a user to tune the parameters of a normalization function Q such as its steepness. Also for LUT-formulated functions tenability can be implemented. Alternatively or additionally the user may formulate higher level rules regarding one or more properties, such as e.g. “only 10 Madonna songs should be played” or “from now on no more Madonna”, which action is automatically translated in the setting the parameters of the normalization function(s) so that the probability for Madonna selection to zero. Lastly the user can also specify graphically e.g. trajectories in property space such as trajectory 203. If e.g. implemented on a clock radio, if the user wakes up only soft songs are played, with an average characteristic corresponding with typical template position 201, and gradually over time the songs become harsher or louder, i.e. towards a typical end-position 202. This again implies transformations of the normalization functions, e.g. by mathematical specification of the parameters or by selecting for a position along the trajectory a most appropriate prestored function.

Advantageously one of the normalization functions may also be a “dislike”/“like” function, where again e.g. on a tanh-shaped function a certain value [0,1] is specified. Song being selected from a particular subset may so be easily promoted or demoted by multiplying with this last function probability (specifying the appropriateness to the user of e.g. that cluster), i.e. songs selected from a particular subset on the basis of normalization functions for different properties become with one instant rating more or less likely to be selected.

As mentioned above, user may have various sets of preferences (that is, functions Q or data representing the functions Q) for various occasions. In a further aspect of the present invention, the user has one or more sets of preferences or “user profiles” stored on one or more storage devices. An example of a suitable storage device is shown in FIG. 5. In the present example, the memory device 10 is a so-called memory stick which fits in the USB port of a computer or other device. However, other storage devices may also be used, such as smart cards, transponders, cellular telephones, CDs, etc.

A single storage device may store several user profiles, giving the user the option of selecting one of these profiles. In a particularly advantageous embodiment, however, the user has several storage devices, each storage device storing a user profile. The user may, for example, have three memory sticks 10 of the type illustrated in FIG. 5, each memory stick 10 storing another set of preferences. The first memory stick may, for example, “prefer” classical music (that is, assign a high weighing factor qⱼ to the property vⱼ corresponding with classical music), while the second memory stick may “prefer” hard rock music. In the first memory stick, the function Q corresponding with “type of music” may even set a qⱼ of hard rock items to zero, thus effectively eliminating those items from the selection, see formula (2) above. In an advantageous further embodiment, the individual storage devices have different colors to assist the user in selecting the appropriate storage device.

Alternatively, or in addition to the functions Q, a storage device (for example a memory stick as mentioned above) may store normalized weighing factors qᵢⱼ, item specific weighing factors qᵢ and/or likelihood factors pᵢ. A storage device may also be used for storing a selection history reflecting past selections. Such a selection history may be used for avoiding the re-selection of an item within a certain amount of time, for example by temporarily setting the item specific weighing factor qᵢ or the likelihood factor pᵢ of the item to zero. The history may comprise a list of previously selected items and/or a list of previously used parameters, such as Qⱼ, qᵢ, etc.

In an alternative embodiment, several user profiles are stored on a single storage device and alternative means are provided for letting the user select one of the available user profiles.

It is noted that the user profiles mentioned above are sets of preferences, that is, sets of functions Q or parameters representing these functions. Such parameters may include scaling and/or shifting parameters.

Although the (portable) storage device 10 was explained as storing data for a multimedia selection framework mathematics as above and the first claims it could also store alternative parameters for alternative selection strategies of comparable functionality.

A typical application of the present invention is illustrated in FIG. 6. A multimedia content rendering system 20, such as a music system (e.g. a juke-box, pc based application, home cinema system, etc.), comprises an input/output (I/O) unit 21, a memory (Mem) unit 22, an audio processing (AP) unit 23 and a loudspeaker unit 24 containing one or more loudspeakers or other transducers. The audio processing unit 23 contains an amplifier and other suitable means for transforming stored audio content into an electrical output signal. The memory unit 22 contains multimedia content, such as audio content, which is typically stored in digital form, for example in the well-known MP3 format. The input/output unit 21 is capable of exchanging data with, and in particular receiving data from, the storage device 10. In accordance with the present invention, the storage device contains one or more sets of preferences as discussed above to select content items from the memory 22. The selected content items are then rendered by the loudspeaker unit 24. The system 20 may contain further units that are not shown in FIG. 6 for the sake of clarity of the illustration.

The system 20 and the storage device 10 may be arranged for automatically selecting and playing multimedia items as soon as the system is activated and the storage device 10 is capable of communicating with the system 20 (for instance by inserting the storage device into an appropriate slot). Such an “auto-start” scenario may involve the steps of the storage device 10 transferring a set of preferences to the system 20, a control section of the audio processing unit 23 using the set of preferences to select a multimedia item from the items stored in memory 22, the audio processing unit 23 processing and the loudspeaker unit 24 rendering the selected song. Alternatively, the storage device 10 may have a processor (as is the case with a smart card) for carrying out the selection process, preferably after receiving a list of available items from the system 20. In such an embodiment, therefore, the storage device automatically gathers information regarding the available content.

It is also possible for the storage device to carry a list of items and to assume that the contents of the memory 22 conform to this list. If an item is selected that is not stored in the memory 22, the selection process would be repeated until an item was found that was actually available.

Instead of the audio system 20 shown in FIG. 6, a computer system could be used, comprising a processor for carrying out the method steps of the invention, a memory for storing the method steps and the parameters (such as the weighing factors) used, and a storage medium (such as a hard disc) for storing user preferences and/or items.

It is noted that the present invention provides a method of selecting items which may be carried out in “real time”, that is, as the items are being rendered or used. In the case of a music system, the method of the present invention may be used to select the next song while a song is being played. In this case, the invention provides a set of rules for selecting items. It is also possible for the invention to provide a predetermined list of selected items. In audio applications such a list is referred to as “playlist”.

The preferences of a user (or group of users) as reflected in the functions Q may not only involve the type of music, name of the artist etc. as mentioned above, but also additional selection criteria regarding the progression of items. In the case of songs being selected, the user preferences could prescribe that two subsequent songs should not vary more (or, alternatively, less) than a certain amount in beat (rhythm), “mood”, or other property. Thus, the user preferences may also include a selection style. As stated above, any criteria may be time-dependent.

The present invention is based upon the insight that using weighed properties facilitates the selection of items. The present invention benefits from the further insight that the weighed properties may be used to determine likelihood factors which may be used for selecting the items. Such a playing style stored on the portable storage device may then influence the playing style of items on the friend's multimedia system (e.g. DJ-mode intended for soft evening music reapplied on dance music).

The present invention may not only be used for selecting multimedia items that are to be rendered instantly, but also for so-called “content collection”, the copying of “content” (that is, multimedia items) from a (remote or local) source to a storage device, such as a hard disc or a DVD. Although the present invention has primarily be explained with reference to multimedia items such as songs, video clips, movies, photos, magazine articles, scientific papers, and books, the invention is not so limited and may also be used for selecting objects, such as cars, and other applications, such as candidate selection in recruitment agencies.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. An electronically implemented method of automatically selecting multimedia items, the method comprising the steps of:
determining, for each item (sᵢ), a likelihood factor (pᵢ) on the basis of properties (vᵢⱼ) of the item,
cumulating the likelihood factors (pᵢ) for all items so as to produce a selection range (R) comprised of likelihood factors (pᵢ),
producing a selector number (r) within said range (R), and
comparing the selector number (r) with the cumulated likelihood factors (pᵢ) so as to determine which item (sᵢ) corresponds with the likelihood factor indicated by the selector number (r).

2. The method according to claim 1, wherein the step of determining a likelihood factor (pᵢ) involves determining a normalized weighing factor (qᵢⱼ) for each property (vᵢⱼ) of an item (sᵢ) using a normalization function (Qⱼ).

3. The method according to claim 2, wherein the step of determining a likelihood factor (pᵢ) involves determining a product of all normalized weighing factors (qᵢⱼ) of an item (sᵢ) so as to produce an item specific weighing factor (qᵢ).

4. The method according to claim 3, wherein the step of determining a likelihood factor (pᵢ) involves determining a ratio of an item specific weighing factor (qᵢ) and a sum of all item specific weighing factors.

5. The method according to claim 2, wherein a normalization function (Qⱼ) reflects user preferences.

6. The method according to claim 2, wherein a normalization function (Qⱼ) is time-dependent.

7. The method according to claim 2, wherein a normalization function (Qⱼ) is user-controlled via user-interface interaction.

8. The method according to claim 2, further comprising the step of storing a normalization function (Qⱼ) and/or a weighing factor (qᵢ; qᵢⱼ) and/or a likelihood factor (pᵢ) on a portable storage device (10).

9. The method according to claim 1, further comprising the step of storing a selection history, preferably on a portable storage device (10).

10. The method according to claim 9, in which the step of storing a selection history comprises a step of storing a function over time of properties (vᵢⱼ) of selected to be played or played multimedia items.

11. A computer program product for carrying out the method according to claim 1.

12. A device for automatically selecting multimedia items, the device comprising:
means for determining, for each item (sᵢ), a likelihood factor (pᵢ) on the basis of properties (vᵢⱼ) of the item,
means for cumulating the likelihood factors (pᵢ) for all items so as to produce a selection range (R) comprised of likelihood factors (pᵢ),
means for producing a number (r) within said range (R), and
means for comparing the number (r) with the cumulated likelihood factors (pᵢ) so as to determine the likelihood factor (pᵢ) of which item (sᵢ) corresponds with the number (r).

13. The device according to claim 12, wherein the means for determining a likelihood factor (pᵢ) are arranged for determining a normalized weighing factor (qᵢⱼ) for each property (vᵢⱼ) of an item (sᵢ) using a normalization function (Qⱼ).

14. The device according to claim 13, wherein the means for determining a likelihood factor (pᵢ) are arranged for determining the product of all normalized weighing factors (qᵢⱼ) of an item (sᵢ) so as to produce a item specific weighing factor (qᵢ).

15. The device according to claim 14, wherein the means for determining a likelihood factor (pᵢ) are arranged for determining a ratio of an item specific weighing factor (qᵢ) and a sum of all item specific weighing factors.

16. The device according to claim 13, wherein a normalization function (Qⱼ) reflects user preferences.

17. A device (10) for storing at least one normalization function (Qⱼ) and/or at least one weighing factor (qᵢ; qᵢⱼ) and/or at least one likelihood factor (pᵢ) for use in the device according to claim 12.

18. A portable device (10) for storing a function over time of properties (vᵢⱼ) of selected to be played or played multimedia items.

19. A multimedia system (20), arranged for carrying out the method according to claim 1.
